(19) United States
(12) Patent Application Publication
(10) Pub. No.: US 2008/0040935 A1
(43) Pub. Date: Feb. 21, 2008

(54) Razor and Hair-Cutting Device

(75) Inventor: Robert Gratz, St. Oswald (AT)

Correspondence Address: CHAPMAN AND CUTLER, 111 WEST MONROE STREET, CHICAGO, IL, 60603, US

(73) Assignee: Payer International Technologies GmbH & Co. KG, St. Bartholoma (AT)

(21) Appl. No.: 11/792,890

(22) PCT Filed: Dec. 7, 2005
(86) PCT No.: PCT/AT05/00494

§ 371 Date: Jun. 12, 2007

(30) Foreign Application Priority Data
Dec. 15, 2004 (AT) A 2101/2004

(51) Int. Cl. B26B 21/40; B26B 19/04; B26B 19/38

(52) U.S. Cl. 30/539; 30/346.51; 30/537

(57) ABSTRACT

In a shaver including at least one shaving head (2) having at least one shaving foil and at least one motor-driven shaving cutter oscillating relative to the shaving foil as well as a cover (3) overlapping the shaving head (2), the cover (3) comprises recesses (5) extending transversely to the direction (6) of the oscillating movement of the shaving cutters and whose longitudinal axes, with the direction (6) of the oscillating movement of at least one cutter head, enclose angles at least partially different from 90°.

The invention relates to a shaver including a shaving head having at least one shaving foil and at least one motor-driven shaving cutter oscillating relative to the shaving foil as well as a cover overlapping the shaving head.

Shavers are known in various configurations. In addition to shavers having rotating cutters, shaving heads including at least one shaving foil relative to which a shaving cutter block is oscillatingly moved are, above all, known. A number of variants have also been proposed for the configuration of the cutter blocks. Besides blades that are oriented substantially vertically to the plane of the shaving foil, slotted cutters which are oscillatingly moved relative to the respective recesses of the shearing blade are also known. With the known shaving heads, a plurality of adjacently arranged cutter blocks are mostly provided, wherein, in addition to this configuration, which is particularly preferred for the shaving of short hair, separate long-hair cutters each comprised of a cutting-comb plate and a cutter moved relative to the cutting-comb plate may also be provided, which are in most cases guided so as to be displaceable on the housing of the shaving or hair-cutting device. In that case, a spacer comb may be provided to overlap the long-hair cutter, with the adjustment of the hair length being feasible by changing the distance between the long-hair cutter and the spacer comb. To this end, the spacer comb may, for instance, comprise suitable height adjustment means. In the configuration according to EP 440 980 B1, the spacer comb for the long-hair cutter, as opposed to conventional assemblies, is designed as an element capable of being slipped over the shaving part and long-hair cutter, and stationarily locked on the housing. If a stationary spacer comb is put on a shaving head of this type, the appropriate distance between the spacer comb and the long-hair cutter, and hence the desired hair length, will be adjustable by a shift of the long-hair cutter so as to provide the function of a hair-cutting device.

However, a long-hair cutter is not necessarily suitable for shaving the relatively short hair of a beard. The spacer combs usually employed with long-hair cutters rather make it impossible to safely cover all the face regions grown with beard, while the risk of injury is considerable. There is, however, the need for an adjustment of the cutting length even when shaving a beard. The invention, therefore, aims to provide a shaver by which beard hair is no longer completely shaved to the skin surface, but which rather enables beard hair to be shortened to a defined stubble length without requiring complex additional components.

To solve this object, the shaver according to the invention essentially consists in that the cover of the shaving head comprises recesses extending transversely to the direction of the oscillating movement of the shaving cutters and whose longitudinal axes, with the direction of the oscillating movement of at least one shaving cutter, enclose angles at least partially differing from 90°. The use of the cross section or thickness of the cover usually slipped on such a shaver as a protective cap for the definition of the beard stubble length and the provision of the cover with defined recesses, on the one hand, ensure the protection of the shaving foil in a conventional manner and, on the other hand, offer the option to feed the beard hair to the shaving foil through such recesses or slots, which beard hair will then be shortened to a length corresponding to the material thickness of the cover. At the same time, such a cover offers the advantage of moisture being able to evaporate from the shaving head after conventional use, wherein, for the desired use as a stubble trimmer, the geometry of the recesses may be optimized to enable the beard hair to be accordingly reliably straightened and seized in order to cause the desired shortening to the desired length. This is safe-guarded by the oblique positions of the longitudinal axes of the recesses relative to the direction of the oscillating movement, since such shavers are, as a rule, guided along the skin in a manner relatively precisely vertical to the direction of the oscillating movement of the cutter block. During such movement, beard hairs will collide with the edges of the recesses or slots and, thus, be repelled in the direction to the shaving foil so as to be safely seizable by the shaving cutter. This applies the more as a number of known shaving heads, in addition to the already described blades oriented substantially vertically to the shaving foil, also comprise slotted knives which are moved to oscillate relative to the recesses of the shaving foil and, bearing in mind the slots which are usually larger in that case, are, therefore, particularly suitable to safely seize longer hair. By contrast, most shaving foils have only relatively small openings, which may only be successfully used for the cutting of long hairs if the latter are accordingly frequently moved out of their original positions. This will, in particular, be feasible in a simple manner if, as in correspondence with a preferred further development, the configuration is devised such that the recesses are designed as corrugated slots.

A geometry that is particularly favorable for seizing such beard stubbles is obtained in that the slots extending transversely to the direction of the oscillating movement comprise slot regions which are alternately inclined to the direction of the oscillating movement, whereby the longitudinal axes of adjacent slot regions mutually enclose angles of between 80° and 120° and, in particular, an angle of >90°. By such a configuration, it is feasible with a minimum of expenditure to achieve a good constancy of the remaining length of the beard hair and, hence, the impression of a so-called “designer stubble”.

In order to promote the straightening of stubbles and the safe delivery to the shaving cutters, the configuration is advantageously devised such that knobs or ledges projecting beyond the enveloping surface of the cover are arranged adjoining the edges of the slots. The ledges or knobs may be arranged such that the hairs will be oriented in the shaving direction, optionally straightened, and fed to the recesses. The knobs or ledges may, for instance, be arranged on a slot narrow side, or on both narrow sides of the slots. In the event that the slots are designed to be divided transversely to the direction of oscillation of the shaving cutters, knobs may, for instance, be provided on the edges of the cover and in the center of the cover, between the two regions of the dividedly designed slots. In order to enhance the straightening of the hair, the knobs or ledges can be made of a material that is softer than the material of the cover, for instance a soft synthetic material, whereby also a stretching of the skin will, at the same time, be reached, which will further contribute to the straightening of the hair. The knobs or ledges may be arranged either directly on the cover or on a separate carrier element capable of being slipped onto the cover.

A preferred configuration will also result if the boundary surfaces of the recesses comprise notches and protrusions or are formed with jags. Thereby, an additional number of edges will be provided, which serve to straighten and orient the beard hair.

In order to reach a uniform cutting length over the entire region of the shaving foil, the configuration is advantageously further developed such that the cover, in the region of the recesses, comprises a shape corresponding with the enveloping surface of the shaving head. A distance that is substantially equal over the entire region of the shaving system will, thus, be ensured between the shaving system and the cover, with the cover being able to substantially rest directly on the shaving head.

In order to obtain different stubble lengths, it is advantageous to provide an appropriate plurality of cover caps for the shaver according to the invention, wherein the configuration is advantageously devised such that a plurality of covers having different material thicknesses or different enveloping-surface radii of curvature and legs capable of being clampingly slipped on the same shaving head are provided.

In the following, the invention will be explained in more detail by way of an exemplary embodiment schematically illustrated in the drawing. Therein:

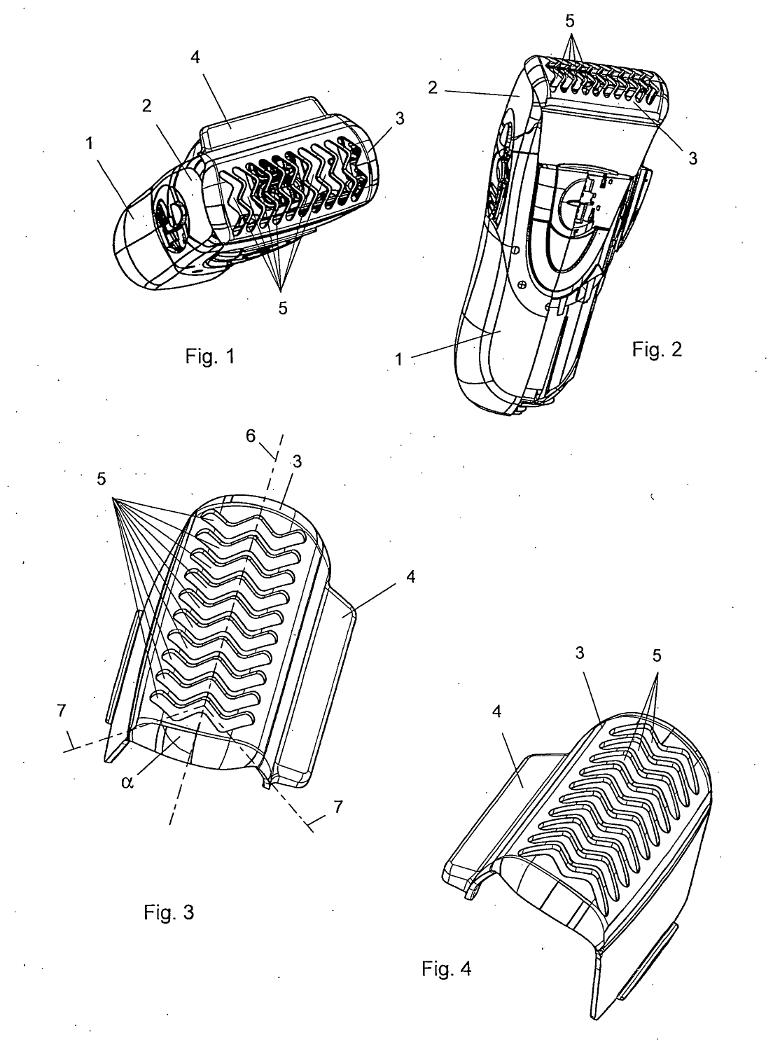

FIGS. 1 and 2 are perspective views of a shaver with the cover put on;

FIGS. 3 and 4 are each an enlarged illustration of the cover overlapping the shaving head;.

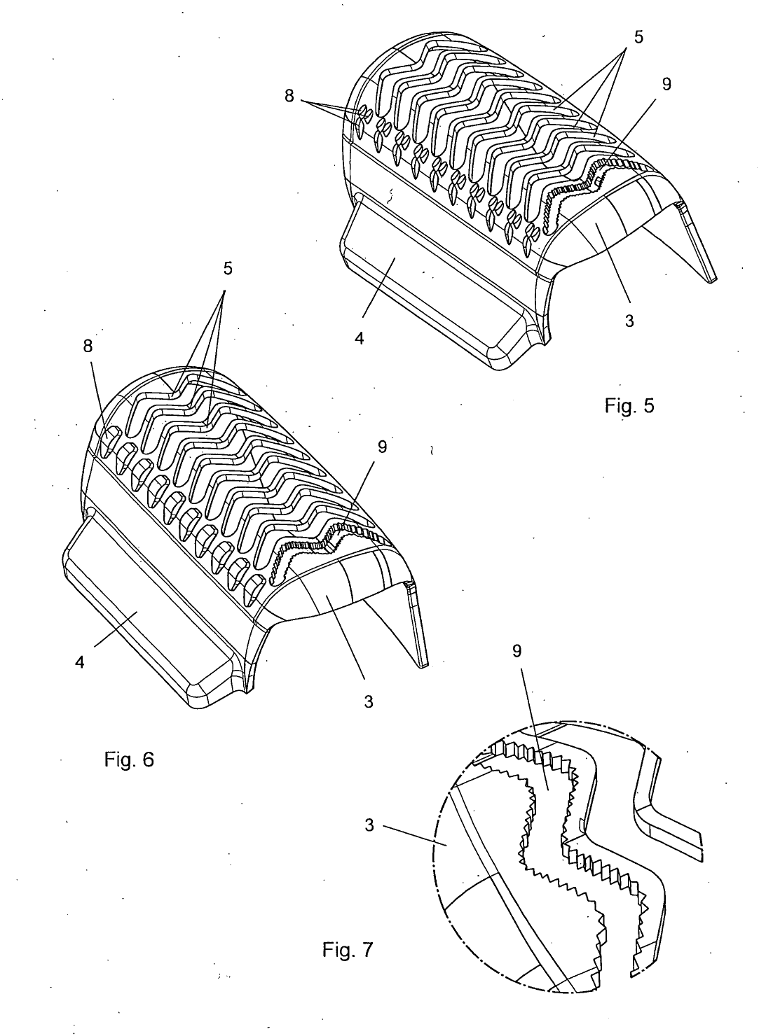

FIGS. 5 and 6 depict modified configurations of the cover; and

FIG. 7 is an enlarged illustration of a slot according to the configuration of FIGS. 5 and 6.

In FIGS. 1 and 2, a shaver base part containing the motor is denoted by 1. By 2, a shaver head is denoted, on which a cover 3 is placed, which, by its zone 4, also covers the long-hair cutter provided in the shaver to protect it from damage. The cover 3 includes slots 5 extending in a wave-shaped manner, as is illustrated on an enlarged scale in FIGS. 3 and 4.

In FIG. 3, the direction of the oscillating movement of the shaver head is schematically indicated by 6, and it is apparent that the individual portions of the wave-likely extending slots 5 are each arranged at an acute angle relative to the direction of the oscillating movement 6. The axes of these portions are schematically indicated by 7, an angle a of <90° being each enclosed between the axes 7 of the respective linearly extending portions and the direction of the oscillating movement as indicated by the axis 6. The axes 7 of the linearly extending portions of the corrugated slots each enclose an angle 2 a in the order of 100°.

FIG. 5 depicts a modified embodiment of the cover cap, in which knobs 8 are each assigned to the slots 5, serving to orient the beard hairs in the shaving direction and feed them to the slots. With the configuration according to FIG. 5, three knobs 8 are assigned to each slot, said knobs each being only arranged on one of the narrow sides of the slots. As already pointed out above, the knobs may also be provided on both narrow sides of the slots. In the configuration according to FIG. 6, only one large knob 8 is assigned to each slot. It is also apparent that the slots 5 may be jagged on their boundary surfaces, as is exemplified in the drawing by way of the slot denoted by 9. An enlarged illustration of the jagged boundary surface is depicted in FIG. 7.

1. A shaver comprising at least one shaving head (2) having at least one shaving foil and at least one motor-driven shaving cutter oscillating relative to the shaving foil and a cover (3) overlapping the shaving head (2), wherein
the cover (3) comprises recesses (5) extending transversely to the direction (6) of the oscillating movement of the shaving cutter and whose longitudinal axes (7), with the direction (6) of the oscillating movement of at least one shaving cutter, enclose angles at least partially different from 90°, and
the recesses (5) extending transversely to the direction of the oscillating movement comprise recess regions which are alternately inclined to the direction (6) of the oscillating movement, wherein the longitudinal axes (7) of adjacent recess regions mutually enclose angles of between 80° and 120°.

2. A shaving and hair-cutting device according to claim 1, wherein the recesses (5) are designed as corrugated slots.

3. A shaver according to claim 1, wherein the longitudinal axes (7) of the adjacent recess regions mutually enclose angles of between 90° and 120°.

4. A shaver according to claim 1, wherein the cover (3), in the region of the recesses (5), comprises a shape corresponding with an enveloping surface of the shaving head.

5. A shaver according to claim 1, wherein knobs (8) or ledges projecting beyond the an enveloping surface of the cover (3) are arranged adjoining edges of the recesses (5).

6. A shaver according to claim 1, wherein boundary surfaces of the recesses (5) comprise notches and protrusions, or are formed with jags.

7. A shaver according to claim 1, further comprising a plurality of covers (3), each of said covers (3) having different material thicknesses or different enveloping-surface radii of curvature, and having legs capable of being clampingly slipped on the same shaving head (2).

8. A cover for slipping on a shaver including a shaving head (2) having at least one shaving foil and at least one motor-driven shaving cutter oscillating relative to the shaving foil, wherein
the cover (3) comprises recesses (5) extending transversely to the direction (6) of the oscillating movement of the shaving cutter and whose longitudinal axes (7), with the direction (6) of the oscillating movement of at least one shaving cutter, enclose angles at least partially different from 90°, and
the recesses (5) extending transversely to the direction of the oscillating movement comprise recess regions which are alternately inclined to the direction (6) of the oscillating movement, wherein the longitudinal axes (7) of adjacent recess regions mutually enclose angles of between 80° and 120°.

9. A cover according to claim 8, wherein the recesses (5) are designed as corrugated slots.

10. A cover according to claim 8, wherein the longitudinal axes (7) of adjacent recess regions mutually enclose angles of between 90° and 120°.

11. A cover according to claim 8, wherein the cover (3), in the region of the recesses (5), comprises a shape corresponding with an enveloping surface of the shaving head.

12. A cover according to claim 8, wherein knobs (8) or ledges projecting beyond an enveloping surface of the cover (3) are arranged adjoining edges of the recesses (5).

13. A cover according to any claim 8, wherein boundary surfaces of the recesses (5) comprise notches and protrusions or are formed with jags.

14. A cover according to claim 8, wherein a plurality of covers (3) are provided, each of said covers (3) having difference material thicknesses or different enveloping-surface radii of curvature, and having legs capable of being clampingly slipped on the same shaving head (2).

15. A cover according to claim 8, wherein the recesses (5) extending transversely to the direction (6) of the oscillating movement of the shaving cutter, in the direction (6) of the oscillating movement, each have a width that is smaller than a recess length measured transversely to said width, wherein the longitudinal axis (7) of the recesses (5), with the direction (6) of the oscillating movement of at least one shaving cutter, enclose angles at least partially different from 90°.

16. A shaver according to claim 2, wherein the longitudinal axes (7) of the adjacent recess regions mutually enclose angles of between 90° and 120°.

17. A shaver according to claim 2, wherein the cover (3), in the region of the recesses (5), comprises a shape corresponding with an enveloping surface of the shaving head.

18. A shaver according to claim 2, wherein knobs (8) or ledges projecting beyond an enveloping surface of the cover (3) are arranged adjoining edges of the recesses (5).

19. A shaver comprising at least one shaving head (2) having at least one shaving foil and at least one motor-driven shaving cutter oscillating relative to the shaving foil and a cover (3) overlapping the shaving head (2), wherein
the cover (3) comprises recesses (5) extending transversely to the direction (6) of the oscillating movement of the shaving cutter and whose longitudinal axes (7), with the direction (6) of the oscillating movement of at least one shaving cutter, enclose angles at least partially different from 90°,
the recesses (5) extending transversely to the direction of the oscillating movement comprise recess regions which are alternately inclined to the direction (6) of the oscillating movement, wherein the longitudinal axes (7) of adjacent recess regions mutually enclose angles of between 90° and 120°,
the recesses (5) are designed as corrugated slots,
the cover (3), in the region of the recesses (5), comprises a shape corresponding with an enveloping surface of the shaving head,
knobs (8) or ledges projecting beyond an enveloping surface of the cover (3) are arranged adjoining edges of the recesses (5), and
boundary surfaces of the recesses (5) comprise notches and protrusions, or are formed with jags.

20. A cover according to claim 9, wherein
the cover (3), in the region of the recesses (5), comprises a shape corresponding with an enveloping surface of the shaving head,
knobs (8) or ledges projecting beyond an enveloping surface of the cover (3) are arranged adjoining edges of the recesses (5),
boundary surfaces of the recesses (5) comprise notches and protrusions or are formed with jags, and
the recesses (5) extending transversely to the direction (6) of the oscillating movement of the shaving cutter, in the direction (6) of the oscillating movement, each have a width that is smaller than a recess length measured transversely to said width, wherein the longitudinal axis (7) of the recesses (5), with the direction (6) of the oscillating movement of at least one shaving cutter, enclose angles at least partially different from 90°.
